(19) United States
(12) Patent Application Publication
(10) Pub. No.: US 2009/0038927 A1
(43) Pub. Date: Feb. 12, 2009

(54) POWER CABLE

(75) Inventors: Guo-Fu Guo, Shenzhen (CN); Chang-Chun Liu, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/941,980

(22) Filed: Nov. 19, 2007

(30) Foreign Application Priority Data
Aug. 9, 2007 (CN) 200710201321.8

(51) Int. Cl. H01R 13/70

(52) U.S. Cl. 200/51 R

(57) ABSTRACT

An exemplary power cable includes a power plug comprising a first prong and a second prong for being plugged into an electric outlet; a cable comprising a live line and a neutral line each having an end connected to the first and second prongs of the power plug respectively; and a socket comprising a first jack and a second jack, wherein the first jack is connected to the opposite end of the live line via a switch. Therefore, users can turn off a standby power of a computer system by turning off the switch.

### BACKGROUND

1. Field of the Invention

The present invention relates to a power cable.

2. Description of Related Art

Conventionally, standby power (such as 5V_SB) is still supplied to a computer system by a computer power supply when the computer system is turned off. Thus, users can wake up the computer system by a keyboard or network operation. Therefore, users have to pull out a power cable of the computer or turn off an electric outlet coupled to the computer power supply to turn off the standby power of the computer system for saving power if they do not plan to wake up the computer system. For the former case, the power cable may wear out from being repeatedly removed from the outlet by users when they turn off the computer system. For the latter case, users have to turn off the electric outlet which may be inconvenient.

### SUMMARY

An exemplary power cable includes a power plug comprising a first prong and a second prong for being plugged into an electric outlet; a cable comprising a live line and a neutral line each having an end connected to the first and second prongs of the power plug respectively; and a socket comprising a first jack and a second jack, wherein the first jack is connected to the opposite end of the live line via a switch.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is an isometric view of a power cable in accordance with the present invention having a socket; and

FIG. 2 is an enlarged view of the socket of FIG. 1.

### DETAILED DESCRIPTION

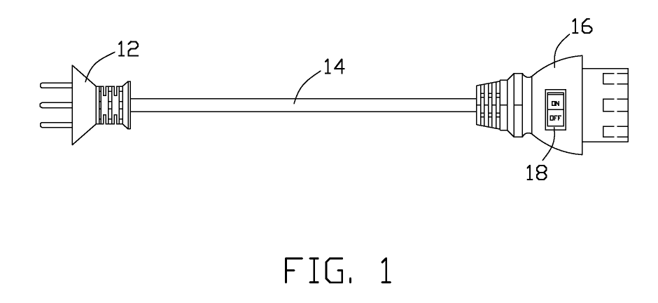

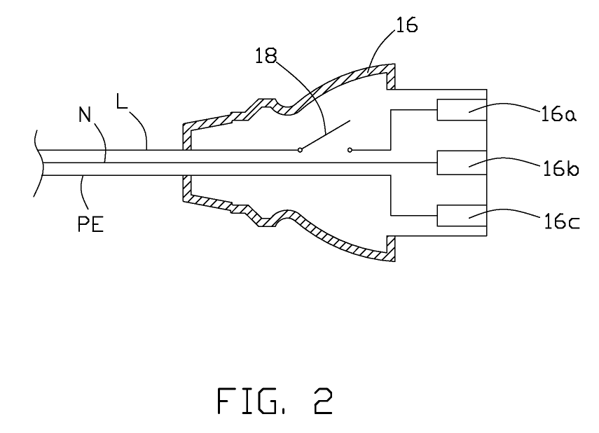

Referring to FIG. 1 and FIG. 2, a power cable in accordance with an embodiment of the present invention includes a power plug 12, a cable 14, and a socket 16. The power plug 12 includes three prongs, which can be plugged into an electric outlet. The cable 14 includes a live line L, a neutral line N, and a ground line PE. The socket 16 includes a first jack 16a, a second jack 16b and a third jack 16c, wherein the first jack 16a is connected to the first prong of the power plug 12 via a switch 18 and the live line L in turn, and the second and third jacks 16b and 16c are connected to the second and third prongs of the power plug 12 via the neutral line N and the ground line PE respectively. In this embodiment of the invention, the switch 18 is a single-pole single-throw switch mounted on a shell of the socket 16 with the throw coupled with the live line L of the cable 14 and the pole coupled with the first jack 16a of the socket 16.

In another embodiment of the invention, the switch 18 is a double-pole double-throw switch with the throws coupled with the live line L and the neutral line N respectively, and the poles coupled with the first and second jacks 16a and 16b. The shell of the socket 16 has a hole exposing the switch 18 for operation.

Therefore, users can turn off standby power of a computer system by operating the switch 18 of the socket 16 without turning off the electric outlet or pulling out the power cable.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A power cable comprising:
a power plug comprising a first prong and a second prong for being plugged into an electric outlet;
a cable comprising a live line and a neutral line each having an end connected to the first and second prongs of the power plug respectively; and
a socket comprising a first jack and a second jack, wherein the first jack is connected to the opposite end of the live line via a switch.

2. The power cable as claimed in claim 1, wherein the switch is a single-pole single-throw switch, and the second jack of the socket is connected to the opposite end of the neutral line.

3. The power cable as claimed in claim 1, wherein the switch is a double-pole double-throw switch, the first and the second jack of the socket are connected to the opposite end of the live line and neutral line respectively via the switch.

4. A power cable comprising:
a cable comprising a live line and a neutral line;
a power plug configured for connecting to an electric outlet, the power plug connected to an end of the cable;
a socket comprising a shell enclosing the opposite end of the cable, a first jack connected to the live line via a switch, and a second jack connected to the neutral line.

5. The power cable as claimed in claim 4, wherein the shell has a hole exposing the switch for operation.

6. The power cable as claimed in claim 5, wherein the switch is a double-pole double-throw switch, the first and the second jack of the socket are connected to the opposite end of the live line and the neutral line respectively via the switch.

7. The power cable as claimed in claim 5, wherein the cable further includes a ground line, the socket further includes a third jack connected to the ground line of the cable.
